(19) United States
(12) Patent Application Publication
(10) Pub. No.: US 2019/0058497 A1
(43) Pub. Date: Feb. 21, 2019

(54) TRANSMITTER, COMMUNICATION UNIT AND METHOD FOR REDUCING HARMONIC DISTORTION IN A TRAINING MODE

(71) Applicant: MediaTek, Inc., Hsin-Chu (TW)

(72) Inventors: Toru Matsuura, Cupertino, CA (US); Ankush Goel, Chandigarh (IN); Keng Leong Fong, Sunnyvale, CA (US)

(73) Assignee: MediaTek, Inc.

(21) Appl. No.: 16/022,937

(22) Filed: Jun. 29, 2018

Related U.S. Application Data
(60) Provisional application No. 62/545,591, filed on Aug. 15, 2017.

(51) Int. Cl. H04B 1/04; H04L 25/02

(52) U.S. Cl. CPC H04B 1/0475; H04B 2001/0425; H04L 25/02

(57) ABSTRACT

A communication unit having a transmitter and method of harmonic distortion content reduction is described. The transmitter is configured to operate in a training mode of operation and a normal transmission mode of operation. The transmitter includes a signal generator; a digital predistortion, DPD, circuit; and a first frequency shift circuit to frequency shift a signal for transmission in a first frequency direction. A feedback path and a second frequency shift circuit frequency shifts a fed back power amplified predistorted signal portion in a second frequency direction opposite to the first frequency direction. A calibration engine, receives and compares a digital baseband signal representative of a signal for transmission with the fed back power amplified predistorted signal portion shifted in the second frequency direction to determine at least one DPD compensation value only during a training mode of operation.

### FIELD OF THE INVENTION

The field of this invention relates to a transmitter, a communication unit and a method for pre-distortion calibration, and in particular to methods for controlling or reducing harmonic distortion during a calibration training mode of operation.

### BACKGROUND OF THE INVENTION

A primary focus and application of the present invention is the field of transmitters and radio frequency (RF) power amplifiers capable of use in wireless telecommunication applications. Continuing pressure on the limited spectrum available for radio communication systems is forcing the development of spectrally-efficient linear modulation schemes. Since the envelopes of a number of these linear modulation schemes fluctuate, these result in the average power delivered to the antenna being significantly lower than the maximum possible power, leading to poor efficiency of the power amplifier. Specifically, in this field, there has been a significant amount of research effort in developing high-power efficient topologies capable of providing useful performance in the ‘back-off’ (linear) region of the power amplifier.

Linear modulation schemes require linear amplification of the modulated signal in order to minimise undesired out-of-band emissions from spectral re-growth. However, the active devices used within a typical RF power amplifier are inherently non-linear by nature. Only when a small portion of the consumed direct current (DC) power is transformed into RF power, can the transfer function of the amplifying device be approximated by a straight line, i.e. as in an ideal linear amplifier. This mode of operation provides a low efficiency of DC to RF power conversion.

Additionally, the emphasis in portable (subscriber) equipment is to increase battery life. To achieve both linearity and efficiency, so called linearization techniques are used to improve the linearity of the more efficient amplifier classes, for example class ‘AB’, ‘B’ or ‘C’ amplifiers. A number and variety of linearizing techniques exist, such as Cartesian Feedback, Feed-forward, and Adaptive Digital Pre-distortion (DPD), which are often used when designing linear transmitters.

In order to increase the bit rate used in transmit uplink communication channels, larger constellation modulation schemes, with an amplitude modulation (AM) component are being investigated and, indeed, becoming required. These modulation schemes, such as sixteen-bit quadrature amplitude modulation (16-QAM), require linear PAs and are associated with high ‘crest’ factors (i.e. a degree of fluctuation) of the modulation envelope waveform. This is in contrast to the previously often-used constant envelope modulation schemes and can result in significant reduction in power efficiency and linearity.

To help overcome such efficiency and linearity issues, for various communications standards, a number of techniques have been proposed.

Referring to FIG. 1, a known output power spectrum mask 100 shows the output power limits vs bandwidth from a carrier frequency 115 of a transmitter that employs a linearizing technology, which in this illustration is a WiFi™ transmission. As illustrated, in WiFi™ enabled devices, the output power spectrum 100 requirement limits the output power 105. Linearization techniques, for example using pre-distortion, that may be employed to linearize the transmit signal, are unable to prevent spectral regrowth 110 at low output power levels distal from the carrier frequency 115. Furthermore, high modulation schemes have recently been popular in order to support ever higher throughput. For example, in 802.11, the error vector magnitude (EVM) requirement increases from −5 dB (BPSK)-->−13 dB (QPSK)-->−19 dB (16 QAM)-->−27 dB (64 QAM)-->−32 dB (256 QAM)-->−35 dB (1024 QAM). In order to achieve this level of accuracy, the linearity requirement increases. Thus, mechanisms to better control spectral regrowth are desired.

FIG. 2 illustrates a block diagram 200 of a known transmitter architecture that uses a digital pre-distortion (DPD) technique. Here, a signal generator 205 generates a DPD digital training signal (X_{ref}) 210 at a baseband frequency (f_{BB}) that is routed through the transmitter circuit, converted to analog form in a digital-to-analog converter (DAC) contained within RF modulator 220 and particularly routed through a power amplifier 225, such that the output signal (X_{PA}) 230 is an amplified analog representation of the DPD digital training signal (X_{ref}) 210. A portion of the output signal (X_{PA}) 230 is routed back to the DPD circuit and converted back to digital form 240 in analog-to-digital converter (ADC) contained within RF demodulator 235, and subsequently compared to the DPD digital training signal (X_{ref}) 210 in a comparison circuit located with a calibration circuit (engine) 250. The calibration circuit (engine) 250 determines how the transmitter circuitry, and particularly the power amplifier 225, has affected the DPD digital training signal (X_{ref}) 210 by analyzing the output from the comparison circuit and determining PA nonlinearity (amplitude modulated to amplitude modulated (AM-to-AM) and amplitude modulated to phase modulated (AM-to-PM)) effects. The calibration circuit (engine) 250 then adapts phase and gain components in the DPD compensation circuit 215 that, effectively, pre-distorts the input signal, e.g. DPD digital training signal (X_{ref}) 210, to compensate for the subsequent non-linearity and distortion effects that will be caused to the input signal by the transmitter circuit. Thereafter, a compensation process is employed, whereby a modulation signal is generated and adapted according to determined DPD values, for example as potentially stored in a DPD look-up table (LUT).

In this manner, a linear transmitter signal is output from the power amplifier, with the inherent non-linearity effects that would have been created cancelled out by the DPD applied by the DPD compensation circuit 215.

As illustrated, the block diagram 200 of the known transmitter architecture includes a frequency generation circuit that, typically, includes a phase locked loop 260 that generates the RF frequency that is used for up-conversion of the pre-distorted digital training signal (X_{ref}) 210 to a radio frequency in RF modulator 220 and the same RF frequency that is used for down-conversion of the fed-back RF representation of the pre-distorted digital training signal (X_{ref}) 210 to a baseband signal in RF demodulator 235. As the RF signal output from the PLL 260 inevitably has some harmonic content, this signal includes (at least) a fundamental carrier signal (f_{RF}) and a 3^{rd} harmonic of (3f_{RF}). Typically, the DPD digital training signal (X_{ref}) 210 is a baseband ramp signal with, say, a frequency=f_{BB}. Hence, when this PLL (local oscillator (LO) signal) of: f_{RF}+3f_{RF}+5f_{RF}+ . . . is mixed with the digital training signal (X_{ref}) 210, the output from the RF modulator 220 is of a form of:

xLO (where the frequency is f_{RF}+f_{BB})+x3LO (where the frequency is 3f_{RF}+f_{BB})+x5LO (where the frequency is 5f_{RF}+f_{BB})+ . . . [1]

After the generated RF signal of the pre-distorted digital training signal (X_{ref}) 210 is amplified by the power amplifier, the output power amplified signal is of a form of:

[The fundamental frequency components of] (f_{RF}+f_{BB})+a third harmonic distortion component (HD3) of 3f_{RF}+3f_{BB}, (as x3LO is attenutated by the PA gain/frequency response)+HD5 (where the frequency is 5f_{RF}+5f_{BB})+ . . . [2]

The calibration circuit (engine) 250 determines PA nonlinearity by measuring nf_{BB} (n:odd integer), where the PA's 3^{rd} order distortion at a frequency of 3f_{RF}+3f_{BB} can mix with the PLL's 3f_{RF} frequency and down convert to a baseband frequency of: 3f_{BB}. The inventors of the present invention have recognized and appreciated that this may have the disadvantage that the PA's 3^{rd} order distortion at a frequency of 3f_{RF}+3f_{BB} has a negative impact on, and, thus, interferes with the desired signal and affects the stored DPD compensation values.

In order to meet the transmitter requirements, such as output power spectrum requirement limits and error vector magnitude, such as those illustrated in FIG. 1, known transmitters may just attenuate the whole output signal to reduce the output power across the whole bandwidth of operation.

U.S. Pat. No. 8,498,591 describes a technique to implement DPD compensation that uses a low bit modulation (quadrature phase shift keyed (QPSK), 16-level quadrature amplitude modulation (16QAM) modulation schemes. With these less-complex modulation schemes, the interference from harmonics is insufficient to cause problems in meeting the required linearity performance.

However, a number of recently proposed communication systems utilize highly complex modulation schemes, such as 1024QAM or 256QAM. The inventors have recognized and appreciated that for these higher and more complex modulation schemes, the linearity requirements are much more severe and therefore impact of the harmonic distortion content of the PLL is likely to cause a problem.

Thus, there exists a need for a more efficient and cost effective solution to control spectral re-growth and reduce harmonic distortion in RF transmitters, particularly for RF transmitters that employ linearization techniques such as DPD.

### SUMMARY OF THE INVENTION

Accordingly, the invention seeks to mitigate, alleviate or eliminate one or more of the above mentioned disadvantages singly or in any combination.

According to aspects of the invention, there is described a communication unit having a transmitter and a method of harmonic distortion reduction. The transmitter is configured to operate in a training mode of operation and a normal transmission mode of operation. The transmitter includes a signal generator arranged to generate a digital baseband signal that is representative of a signal for transmission; a digital predistortion (DPD) circuit configured to predistort the digital baseband signal; a first frequency shift circuit operably coupled to the DPD circuit and configured to frequency shift the signal for transmission in a first frequency direction; where the frequency-shifted signal is then transmitted to a power amplifier. A feedback path is coupleable to an output of the power amplifier and configured to route a portion of the power amplified predistorted signal to a second frequency shift circuit that is configured to frequency shift the fed back portion of a power amplified predistorted signal in a second frequency direction that is substantially equal to and opposite to the first frequency direction. A calibration engine, located in the feedback path and coupled to the signal generator, is arranged to receive and compare the digital baseband signal representative of a signal for transmission with the fed back portion of the power amplified predistorted signal shifted in the second frequency direction, wherein the calibration engine is configured to determine at least one DPD compensation value to apply to the DPD circuit during a training mode of operation and wherein the first frequency shift circuit and second frequency shift circuit apply the frequency shift in a first direction and a second frequency direction opposite to the first frequency direction only in the training mode of operation.

In this manner, a transmitter architecture that uses a DPD circuit is described whereby the effect of harmonic distortion from one or more of various components in the transmitter line-up can be determined by applying a frequency shift to a transmit signal in a training mode of operation, which is removed from a feedback portion of the signal to be transmitted by a reverse frequency shift in a feedback path.

In an optional example embodiment, the first frequency shift circuit and second frequency shift circuit comprise single sideband mixers configured to receive a frequency shift signal and the signal for transmission and generate a frequency shifted signal for transmission on a single sideband of the signal for transmission. In this optional example embodiment, the use of SSB mixers removes a possibility of image signals being generated that may interfere with the desired signal.

In an optional example embodiment, the first frequency shift circuit is located before the DPD circuit in a transmitter path. In this optional example embodiment, the location of the first frequency shift circuit, for example using a first SSB mixer, before the DPD circuit in a transmitter path. Alternatively, in an optional example embodiment, the first frequency shift circuit is located after the DPD circuit in a transmitter path. In this optional example embodiment, the location of the first frequency shift circuit, for example using a first SSB mixer, after the DPD circuit in a transmitter path enables, in some examples, for the DPD clock frequency to be lower if the frequency shift of the SSB is large.

In an optional example embodiment, the feedback path further comprises a filter located between the second frequency shift circuit and the calibration engine. In this optional example embodiment, the location of the filter between the second frequency shift circuit and the calibration engine may remove the signal related to the transmitter third harmonic distortion component HD3.

In an optional example embodiment, the frequency shift circuits are bypassed in the normal transmission mode of operation. In this optional example embodiment, the ability to bypass the frequency shift circuits in the normal transmission mode of operation may avoid an increase in the DAC clock frequency.

In an optional example embodiment, the transmitter further includes a radio frequency modulator comprising at least one low pass filter, LPF, coupled to at least one mixer in a forward path and a radio frequency demodulator located in the feedback path. In this optional example embodiment, when the frequency shift of SSB mixer is large, the training (calibration) signal may be attenuated significantly by the LPF. A use of a bypass circuit to bypass the LPF in a training mode of operation or an extension of the LPF cutoff frequency may be used to keep the signal level high.

In an optional example embodiment, the transmitter forward path may include a pre-emphasis filter located before the RF demodulator, wherein the pre-emphasis filter is configured to compensate for a frequency response applied to the transmit signal by the RF demodulator. In this optional example embodiment, the ability to compensate for a frequency response applied to the transmit signal by the RF demodulator using a pre-emphasis filter may also attenuate the signal. Again, a use of a bypass circuit to bypass the LPF in a training mode of operation or an extension of the LPF cutoff frequency may be used to keep the signal level high.

These and other aspects of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the FIGs are illustrated for simplicity and clarity and have not necessarily been drawn to scale.

FIG. 1 illustrates a known output power spectrum showing the power limits vs frequency of a WiFi™ transmission.

FIG. 2 illustrates a block diagram of a known transmitter architecture that uses a digital pre-distortion (DPD) technique.

FIG. 3 illustrates a simplified block diagram of an example of a communication unit having a transmitter and DPD circuit, in accordance with some examples of the invention.

FIG. 4 illustrates a first example block diagram of a transmitter with a DPD circuit and calibration engine arranged to reduce harmonic distortion in a calibration training mode of operation in accordance with some examples of the invention.

FIG. 5 illustrates a second example block diagram of a transmitter with a DPD circuit and calibration engine arranged to reduce harmonic distortion in a calibration training mode of operation in accordance with some examples of the invention.

FIG. 6 illustrates a third example block diagram of a transmitter with a DPD circuit and calibration engine arranged to reduce harmonic distortion in a calibration training mode of operation in accordance with some examples of the invention.

FIG. 7 illustrates a fourth example block diagram of a transmitter with a predistortion circuit with reduced harmonic distortion in a normal transmission mode of operation, in accordance with some examples of the invention.

FIG. 8 illustrates an example flowchart of a method to reduce harmonic distortion following a calibration training mode of operation and thereafter use DPD compensation values obtained in the calibration training mode of operation in a normal transmission mode of operation in accordance with some examples of the invention.

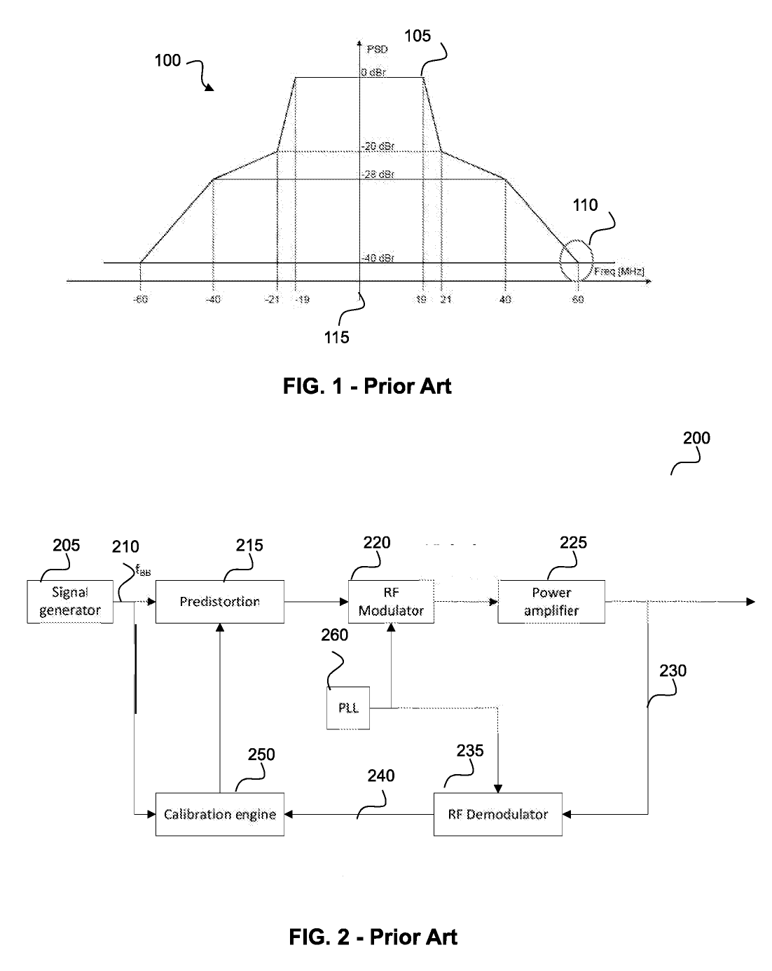

### DETAILED DESCRIPTION

Examples of the invention will be described in terms of various circuits configured to determine DPD compensation values during a calibration training mode of operation to reduce harmonic distortion, for examples as used in a wireless communication unit, such as an user equipment (UE) in Long Term Evolved (LTE™) that employs a digital predistortion circuit. However, it is envisaged that the harmonic distortion reduction concepts herein described may be applicable in any situation or system or communication unit where harmonic control is desired.

In examples of the invention, DPD calibration is performed and in some examples it may be initiated either in a factory set-up, or following power-on of a communication unit, or in response to an operational or environmental change, such as a temperature change, whereby a DPD training signal is used to determine the appropriate transmitter linearization values (i.e. DPD compensation values) to use. In a DPD normal transmission mode of operation, sometimes referred to as a compensation phase, the transmitter outputs the modulation signal that can be compensated by the DPD circuit using the DPD compensation values to reduce the effect of distortion of the transmit signal, i.e. once the transmitter has been calibrated and any associated transmitter performance parameters or circuits adjusted accordingly as obtained during a training mode of operation. The approach to reducing the impact to DPD calibration accuracy by addressing harmonic distortion, and in particular a third harmonic distortion content of a generated signal has not previously been considered in a complex linear transmitter architecture, such as a transmitter employing a DPD circuit, as the modulation schemes previously employed in linearized transmitter systems were less complex, typically with fewer levels, and therefore less affected by harmonic distortion content of a generated signal.

Examples of the invention provide a first frequency shift in a transmitter forward path and a corresponding reverse frequency shift in a feedback path to enable harmonic distortion by the power amplifier to be identified and reduced. This architecture shifts the desired signal and the related third harmonic distortion signal to a different frequency. In some examples, a low pass filter (LPF) in the feedback path may be used to reduce or remove the third order harmonic distortion signal at the calibration engine input to improve the calibration engine accuracy. Some examples of the invention propose, in a calibration training mode of operation, to use a single sideband (SSB) mixer in both the transmitter forward path and the feedback path and which are used to impart a frequency shift of a transmit signal as applied to a power amplifier (and a feedback signal to impart a reverse frequency shift) in order to determine and compensate harmonic distortion content introduced by the PLL and exacerbated by the power amplifier. Thereafter, in some examples and in a normal transmission mode of operation, examples of the invention propose to bypass the SSB mixers when transmitting real signals.

Furthermore, because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

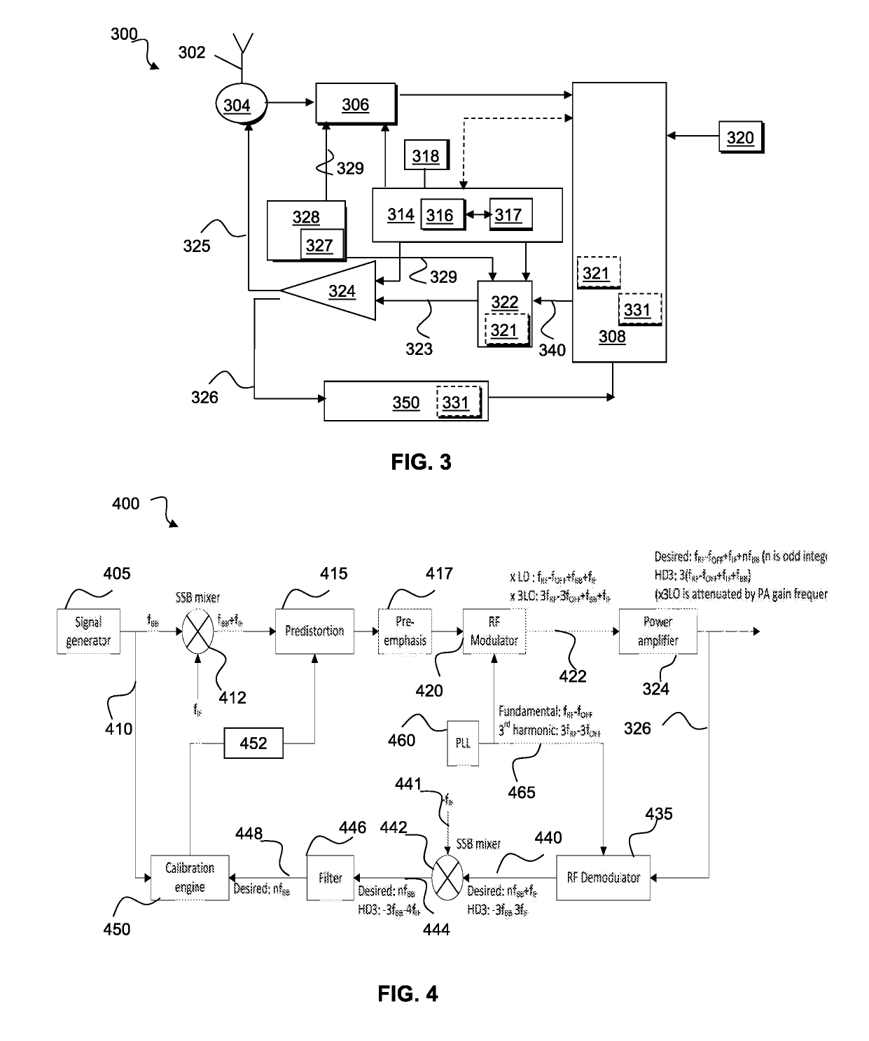

Referring now to FIG. 3, a block diagram of a wireless communication unit 300, adapted in accordance with some example embodiments of the invention, is shown. In practice, purely for the purposes of explaining embodiments of the invention, the wireless communication unit is described in terms of a wireless subscriber communication unit in the form of an user equipment configured to support the LTE™ communication standard. The wireless communication unit 300 contains an antenna arrangement 302, for radiating signals and/or for receiving transmissions, coupled to an antenna switch 304 that provides isolation between receive and transmit chains within the wireless communication unit 300. One or more receiver chains, as known in the art, include(s) receiver front-end circuitry 306 (effectively providing reception, filtering and intermediate or base-band frequency conversion). The receiver front-end circuitry 306 is coupled to a signal processing module 308 (generally realized by a Digital Signal Processor (DSP)). A skilled artisan will appreciate that the level of integration of receiver circuits or components may be, in some instances, implementation-dependent.

A controller 314 maintains overall operational control of the wireless communication unit 300. The controller 314 is coupled to the receiver front-end circuitry 306 and the signal processing module 308. In some examples, the controller 314 is also coupled to a buffer module 317 and at least one memory device 316 that selectively stores data relating to operating functions, such as information relating to DPD gains, look-up-table information (say for a DPD), harmonic distortion levels, frequency shift values and programmable filter parameters to impart an associated filter response, and the like. A timer 318 is operably coupled to the controller 314 to control the timing of operations (e.g. transmission or reception of time-dependent signals) within the wireless communication unit 300.

The transmit chain includes transmitter/modulation circuitry 322 and a power amplifier 324 coupled to the antenna arrangement 302, which may comprise for example an antenna array, or plurality of antennas. The transmitter/modulation circuitry 322 and the power amplifier 324 are operationally responsive to the controller 314. In some examples, the signal processing module 308 and/or controller 314 may receive inputs from one or more input device or sensor modules 320. Frequency generation circuit 328 includes at least one local oscillator, LO, 327 and is operably coupled to the receiver front-end circuitry 306 and the transmitter/modulation circuitry 322 and arranged to provide local oscillator signals 329 thereto.

In example embodiments, the transmit chain includes a first frequency shift circuit 321, which may be located in transmitter/modulation circuitry 322 or within the signal processor 308, or any other suitable circuit, as shown. In some examples herein described, the first frequency shift circuit 321 may encompass or be operably coupled to DPD functionality with a DPD look-up-table (LUT), as described in later figures. In example embodiments, signal processor 308 generates a digital signal, such as a DPD digital training signal that is routed through the transmitter/modulation circuitry 322, frequency shifted by first frequency shift circuit 321 and converted to analog form in a digital-to analog converter (DAC), typically located in transmitter/modulation circuitry 322 and routed through a power amplifier 324, such that the output signal 325 is an amplified analog representation of the DPD digital training signal. In some examples, the first frequency shift circuit 321 may be located within the transmitter/modulation circuitry 322 and in some examples the first frequency shift circuit 321 may be located elsewhere, e.g. in, or coupled to, the signal processor 308, with the specific location dependent upon the desired architecture.

A portion 326 of the output signal 325 is routed back to a second frequency shift circuit 331 configured to apply a reverse frequency shift to the frequency shift imparted on the DPD digital training signal in the forward path and converted back to digital form in down-converter and analog-to-digital converter (ADC) 350. The first frequency shift circuit 321 is configured to apply frequency shifting of a training signal to determine harmonic distortion introduced in to the transmitter, in particular a 3^{rd} order harmonic distortion content introduced for example by a phase locked loop (PLL) frequency generation circuit, in accordance with any one or more of the examples herein described with reference to FIGS. 4 to 9. The second frequency shift circuit 331 is included to counteract the introduced first frequency shift circuit to enable a calibration engine to determine suitable DPD compensation values that address both amplitude modulation and phase modulation effects caused by the power amplifier 324 as well as distortion (around the RF frequency) due to the intermodulation, and in particular to remove the interference that is due to a mixing of the PA's HD3 and PLL output 3rd order signal.

In some examples, the second frequency shift circuit 331 may be located within the down-converter and ADC 350, which may be referred to as an RF demodulator, and in some examples the second frequency shift circuit 331 may be located elsewhere, e.g. in, or coupled to, the signal processor 308, with the specific location dependent upon the desired architecture.

Clearly, a number of the various components within the wireless communication unit 300 can be realized in discrete or integrated component form, with an ultimate structure therefore being application-specific or design-based.

FIG. 4 illustrates a first example block diagram of a digital pre-distortion (DPD) calibration circuit of a linear transmitter 400, adapted in accordance with some examples of the invention. The example illustrated in FIG. 4 applies to a frequency shifting design that is employed only during a DPD training or calibration process. However, in other examples it is envisaged that the frequency shifting during a DPD training or calibration process may be achieved using different circuit architecture.

In this example, a signal generator 405 generates a DPD digital training signal (X_{ref}) 410 that is routed through the transmitter circuit. In this example, an intermediate frequency, f_{IF}, is introduced into the DPD digital training signal (X_{ref}) 410 via a first single sideband (SSB) mixer 412, which outputs a transmit frequency-shifted training signal of f_{BB}+f_{IF}.

In some examples a SSB mixer is proposed as this circuit component may avoid generating interference by the PA 324 due to 3rd harmonics, and only generates a frequency shift and does not generate an additional tone. It is envisaged in other examples that a SSB mixer may be replaced by other frequency conversion components, such as a double sideband mixer, although in this case the circuit would need to be designed to attenuate any other mixed signals that were generated.

The transmit training signal of f_{BB}+f_{IF} is input to the digital predistorter 415, where the digital components (amplitude and phase) of the training signal are (pre-)distorted. In this example transmitter architecture, the output pre-distorted training signal is input to an optional pre-emphasis circuit 417, which is employed in transmitters to equalize the modulating signal frequency response changed by the following transmitter blocks.

The output of the optional pre-emphasis circuit 417 is input to a radio frequency (RF) modulator 420, which includes a digital-to-analog converter (DAC) (not shown) and converts an analog version of the digitally pre-distorted training signal to a radio frequency.

The RF modulator 420 receives a PLL signal from PLL 460 that is of a form of:

The fundamental frequency (LO)+the 3^{rd} harmonic (where the 3LO is: f_{RF}−f_{OFF}+3f_{RF}−3f_{OFF})+the 5^{th} order harmonic (where the 5LO is: 5f_{RF}−5f_{OFF})+ . . . [3]

where the offset frequency (f_{OFF}) is the frequency difference of the PLL between the DPD calibration mode and the normal transmission mode. Typically, the offset frequency is chosen as the same as the intermediate frequency (f_{OFF}=f_{IF})

Hence, when this PLL signal is applied to the digitally pre-distorted training signal, the resultant RF output signal from the RF modulator 420 is of a form of:

xLO (which is: f_{RF}−f_{OFF}+f_{BB}+f_{IF})+x3LO (which is: 3f_{RF}−3f_{OFF}+f_{BB}+f_{IF})+x5LO (which is: 5f_{RF}−5f_{OFF}+f_{BB}+f_{IF})+ . . . [4]

The output from the RF modulator 420 is routed 422 through a power amplifier 324, such that the output signal 326 is an amplified analog representation of the DPD digital training signal (X_{ref}) 410. At this point, the desired RF signal is only xLO in equ. [4], whereas a third harmonic distortion (HD3) component of x3LO is attenuated by the power amplifier 324.

A portion of the output signal 326 is routed back to the DPD circuit 415 via radio frequency (RF) demodulator 435. In this example, the RF demodulator 435 includes a down-mixer and an analog-to-digital converter (ADC). The output of the RF demodulator 435 is a digital representation of: nf_{BB}+f_{IF} together with third harmonic distortion (HD3) content thereof −3f_{BB}−3f_{IF}. In accordance with this example architecture, the down-converted baseband portion of the output signal 326 is input to a second SSB mixer 442. The second SSB mixer 442 subtracts the intermediate frequency, f_{IF}, that was previously introduced, and thereby outputs a feedback transmit training signal of nf_{BB}, together with a further frequency shifted third harmonic distortion content thereof of −3f_{BB}−4f_{IF} 444. The feedback transmit training signal is input to filter 446, which is effectively used to remove the harmonic content of −3f_{BB}−4f_{IF}. The filtered output 448 of nf_{BB} is then input to a calibration circuit (e.g. calibration processing engine) 450, which compares the filtered signal of nf_{BB} to the DPD digital training signal (X_{ref}) 410. An output of the calibration circuit 450 is used to control the pre-distortion coefficients in digital predistorter 415. In some examples, a look-up table 452 may be used to store the determined pre-distortion coefficients.

In this example, the first frequency shift implemented by the first SSB mixer in the transmit path, and the second SSB mixer reversing the frequency shift in the feedback path, is f_{IF}.

In this example architecture, the RF modulator 420 and RF demodulator 435, which are configured to effect up-conversion of a baseband or intermediate frequency signal transmit signal to an RF frequency and down-conversion of the RF fed back signal to a baseband or intermediate frequency signal to be compared to the original transmit signal 410 signal to control the pre-distortion coefficients in digital predistorter 415, are each supplied with the same local oscillator (LO) signal 465. The LO signal is generated by a phase locked loop PLL frequency generation circuit 460, which inevitably includes f_{RF}−f_{OFF} (an offset frequency that sets a desired output frequency from the PA 324) together with third harmonic distortion content thereof: 3f_{RF}−3f_{OFF}.

In operation, the calibration circuit 450 determines how the transmitter circuitry, and particularly the power amplifier 324, has affected the DPD digital training signal (X_{ref}) 410, by analyzing the output from a comparison circuit within the calibration circuit 450 and determining PA nonlinearity (amplitude modulated to amplitude modulated (AM-to-AM) and amplitude modulated to phase modulated (AM-to-PM)) effects. Notably, in accordance with examples of the invention, the application of the respective frequency shifts also enables the 3^{rd} harmonic distortion content of the LO signal to be easily removed by a LPF.

The calibration circuit 450 then adapts phase and gain components in the digital predistorter 415 that, effectively, pre-distorts the input signal, e.g. DPD digital training signal (X_{ref}) 410, to compensate for the subsequent non-linearity and distortion effects that will be caused to the input signal by the transmitter circuit and shape the envelope at same time.

In this manner, the frequency shift by f_{IF} of the transmit signal in the transmitter path via the SSB mixer 412, followed by the reverse frequency shift by f_{IF} of the transmit signal in the feedback path enables the frequency shifted 3^{rd} harmonic distortion content to be removed by LPF filter 446, where the cut-off frequency may be configured to be larger than the IF frequency, or the transmit LPF may be bypassed, or a transmit pre-emphasis filter used to compensate the transmit LPF frequency response or an IF frequency selected that is too small to attenuate the training signal significantly.

Although in this example the introduction (and subsequent removal) of an intermediate frequency shift has been implemented in the digital domain via SSB mixers 412, 442, it is envisaged that the architecture could be adapted such that the intermediate frequency shift may be introduced by analog SSB mixers in the analog domain (i.e. post DAC in the transmitter path and pre-ADC in the receiver path).

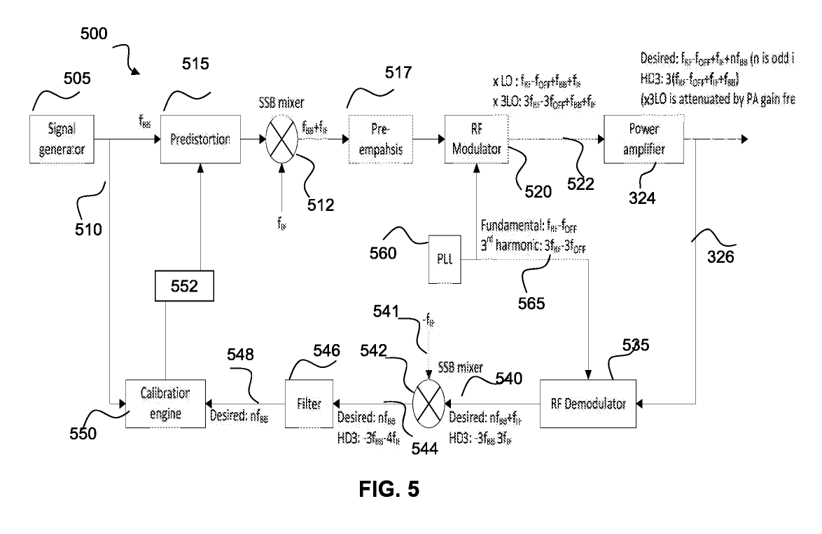

Referring now to FIG. 5, a second example block diagram of a digital pre-distortion (DPD) calibration circuit of a linear transmitter 500, adapted in accordance with some examples of the invention. Circuits and their functional operation will not be described in relation to FIG. 5 if they have been described with reference to FIG. 4, for simplicity purposes only. A skilled artisan will appreciate that some of the teaching of FIG. 4 can be equally applied to the block diagram of FIG. 5. The example illustrated in FIG. 4 applies to a frequency shifting design that is employed only during a DPD training or calibration process. However, in other examples it is envisaged that the frequency shifting during a DPD training or calibration process may be achieved using other circuit architecture.

The example illustrated in FIG. 5 also applies a frequency shifting design implemented using digital single side band mixers, as per FIG. 4, although this example introduces the frequency shifting after the digital pre-distortion function in digital pre-distorter 515. In this example, a signal generator 505 generates a DPD digital training signal (X_{ref}) 510 that is routed through the transmitter circuit. In this example, an intermediate frequency, F_{IF}, is introduced into the DPD digital training signal (X_{ref}) 510 via a first SSB mixer 512, which outputs a transmit training signal of f_{BB}+f_{IF}. The transmit training signal of f_{BB}+f_{IF} is input to the digital predistorter 515, where the digital components of the training signal are (pre-) distorted.

In this example, the frequency shift implemented by the first SSB mixer in the transmit path, and the second SSB mixer reversing the frequency shift in the feedback path, is f_{IF}.

In this example transmitter architecture, the output pre-distorted training signal is input to an optional pre-emphasis circuit 517. The output of the optional pre-emphasis circuit 517 is input to a RF modulator 520, which includes a DAC (not shown) and converts an analog version of the digitally pre-distorted training signal to a radio frequency.

The RF modulator 520 receives a PLL signal from PLL 560 that is of a form of equation [3]. Hence, when this PLL signal is applied to the digitally pre-distorted training signal, the resultant RF output signal from the RF modulator 520 is of a form of equation [4].

The output from the RF modulator 520 is routed 522 through a power amplifier 324, such that the output signal 326 is an amplified analog representation of the DPD digital training signal (X_{ref}) 510. At this point, the desired RF signal is of a form of xLO in equ. [4], whereas it contains a third harmonic distortion (HD3) of the PA input signal (xLO), and x3LO at the PA input is attenuated by the PA gain frequency response. A portion of the output signal 326 is routed back to the DPD circuit 515 via RF demodulator 535.

In this example, the RF demodulator 535 includes a down-mixer and an ADC. The output of the RF demodulator 535 is a digital representation of: nf_{BB}+f_{IF} together with third harmonic distortion content thereof −3f_{BB}−3f_{IF}. In accordance with this example architecture, the down-converted baseband portion of the output signal 326 is input to a second SSB mixer 542. The second SSB mixer 542 subtracts the intermediate frequency, f_{IF}, that was previously introduced, and thereby outputs a feedback transmit training signal of f_{BB}, together with a further frequency shifted third harmonic distortion content thereof of −3f_{BB}−5f_{IF} 544. The feedback transmit training signal is input to filter 546, which is effectively used to remove the harmonic content. The filter output 548 of nf_{BB} is then input to a calibration circuit (e.g. calibration processing engine) 550, which compares the filtered signal of nf_{BB} to the DPD digital training signal (X_{ref}) 510 in a comparison circuit 530. An output of the calibration circuit 550 is used to control the pre-distortion coefficients in digital predistorter 515. In some examples, a look-up table 552 may be used to store the determined pre-distortion coefficients.

In this example architecture, the RF modulator 520 and RF demodulator 535, which are configured to effect up-conversion of a baseband or intermediate frequency signal transmit signal to an RF frequency and down-conversion of the RF fed back signal to a baseband or intermediate frequency signal to be compared to the original transmit signal 510 signal to control the pre-distortion co-efficients in digital predistorter 515, are each supplied with the same LO signal 565. The LO signal is generated by a phase locked loop frequency generation circuit 560, which inevitably includes f_{RF}−f_{OFF} (an offset frequency that sets a desired output frequency from the PA 324) together with third harmonic distortion content thereof: −3f_{RF}−3f_{OFF}.

In operation, the calibration circuit 550 determines how the transmitter circuitry, and particularly the power amplifier 324, has affected the DPD digital training signal (X_{ref}) 510, by analyzing the output from the comparison circuit within the calibration circuit 550 and determining PA nonlinearity (amplitude modulated to amplitude modulated (AM-to-AM) and amplitude modulated to phase modulated (AM-to-PM)) effects. The calibration circuit 550 then adapts phase and gain components in the digital predistorter 515 that, effectively, pre-distorts the input signal, e.g. DPD digital training signal (X_{ref}) 510, to compensate for the subsequent non-linearity and distortion effects that will be caused to the input signal by the transmitter circuit and shape the envelope at same time.

In this manner, the frequency shift by f_{IF} of the transmit signal in the transmitter path by the first SSB mixer 512, followed by the reverse frequency shift by f_{IF} 541 of the transmit signal in the feedback path via the second SSB mixer 542, enables the frequency shifted 3^{rd} harmonic distortion content to be removed by filter 546.

Although in this example the introduction (and subsequent removal) of an intermediate frequency shift has been implemented in the digital domain via SSB mixers 512, 542, it is envisaged that the architecture could be adapted such that the intermediate frequency shift may be introduced by analog SSB mixers in the analog domain (i.e. post DAC in the transmitter path and pre-ADC in the receiver path).

In some examples, assuming digital SSB mixers are used, there is no benefit in locating the DPD before the SSB mixer in the forward path as in FIG. 5 or after the SSB mixer in the forward path as in FIG. 4 as the output from the amplitude modulated (AM) and/or phase modulated (PM) look-up table (LUT) 452, 552 coupled to the DPD circuit 415, 515 is a function of the signal amplitude, and a digital SSB mixer does not change the amplitude.

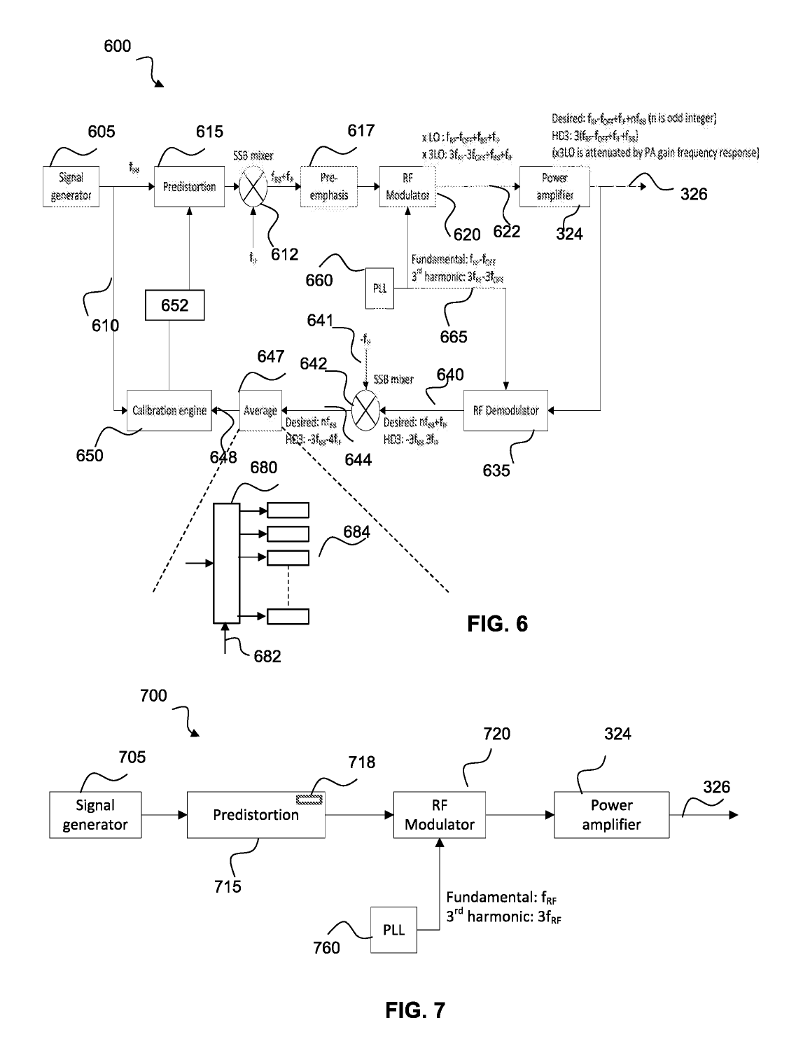

Referring now to FIG. 6, a third example block diagram of a DPD calibration circuit of a linear transmitter 600, adapted in accordance with some examples of the invention. Circuits and their functional operation will not be described in relation to FIG. 6, if they have been described with reference to FIG. 4, for simplicity purposes only. A skilled artisan will appreciate that some of the teaching of FIG. 4 can be equally applied to the block diagram of FIG. 6. The example illustrated in FIG. 6 also applies a frequency shifting design implemented using digital single side band mixers, as per FIG. 4 and FIG. 5, although this example introduces an averaging circuit in the feedback path in order to provide a feedback representation of the transmit signal to a calibration circuit 650.

In this example, a signal generator 605 generates a DPD digital training signal (X_{ref}) 610 that is routed through the transmitter circuit. The DPD digital training signal X_{ref} 610 is input to the digital predistorter 615, where the digital components of the training signal are (pre-) distorted. In this example, an intermediate frequency, F_{IF}, is introduced into an output predistorted DPD digital training signal via a first SSB mixer 612, which outputs a transmit training signal of F_{BB}+F_{IF}. In this example transmitter architecture, the output pre-distorted training signal is input to an optional pre-emphasis circuit 617, which is employed in frequency modulation or phase modulation transmitters to equalize the modulating signal drive power in terms of deviation ratio. The receiver demodulation process includes a reciprocal network, called a de-emphasis network, to restore the original signal power distribution. The output of the optional pre-emphasis circuit 617 is input to a radio frequency modulator 620, which includes a digital-to-analog converter (DAC) (not shown) and converts an analog version of the digitally pre-distorted training signal to a radio frequency (RF) that is routed 622 through a power amplifier 324, such that the output signal 326 is an amplified analog representation of the DPD digital training signal (X_{ref}) 610.

A portion of the output signal 326 is routed back to the DPD circuit 615 via radio frequency (RF) demodulator 635. In this example, the RF demodulator 635, includes a down-mixer and an ADC. The output of the RF demodulator 635 is a digital representation of: nf_{BB}+f_{IF} together with third harmonic distortion content thereof −3f_{BB}−fF_{IF}. In accordance with this example architecture, the down-converted baseband portion of the output signal 326 is input to a second SSB mixer 642. The second SSB mixer 642 subtracts the intermediate frequency, f_{IF}, that was previously introduced, and thereby outputs a feedback transmit training signal of f_{BB}, together with a further frequency shifted third harmonic distortion content thereof of −3f_{BB}−6f_{IF} 644. The feedback transmit training signal is input to averaging circuit 647, which removes the harmonic content. The averaging circuit output 648 of nf_{BB} is then input to a calibration circuit (e.g. calibration processing engine) 650, which compares the filtered signal of nf_{BB} to the DPD digital training signal (X_{ref}) 610 in a comparison circuit 630. An output of the calibration circuit 650 is used to control the pre-distortion coefficients in digital predistorter 615.

In some examples, a use of an averaging circuit 647 does not require a specific filter. In some examples, it is envisaged that the averaging circuit 647 may include a multiplexer 680 that outputs signals to multiple accumulators 684 that may be controlled based on the reference signal (e.g. the DPD digital training signal) level 682. Also, in some examples, the averaging circuit 647 may include a frequency response with a frequency having a large attenuation that is aligned with the frequency that relates to the transmitter's HD3.

In some examples, by choosing an IF that is too close to the notch, it is possible to obtain a benefit that the circuit does not require an additional filter. In this regard, the averaging circuit 647 (or filter in other examples) removes or reduces the third harmonic distortion (HD3) component using −3f_{RF}−4f_{IF}.

In this example architecture, the RF modulator 620 and RF demodulator 635, which are configured to effect up-conversion of a baseband or intermediate frequency signal transmit signal to an RF frequency and down-conversion of the RF fed back signal to a baseband or intermediate frequency signal to be compared to the original transmit signal 610 signal to control the pre-distortion coefficients in digital predistorter 615, are each supplied with the same LO signal 665. The LO signal is generated by a phase locked loop frequency generation circuit 660, which inevitably includes f_{RF}−f_{OFF} (an offset frequency that sets a desired output frequency from the PA 324) together with third harmonic distortion content thereof: −3f_{RF}−3f_{OFF}.

In operation, the calibration circuit 650 determines how the transmitter circuitry, and particularly the power amplifier 324, has affected the DPD digital training signal (X_{ref}) 610, by analyzing the output from the comparison circuit within the calibration circuit 650 and determining PA nonlinearity (amplitude modulated to amplitude modulated (AM-to-AM) and amplitude modulated to phase modulated (AM-to-PM)) effects. The calibration circuit 650 then adapts phase and gain components in the digital predistorter 615 that, effectively, pre-distorts the input signal, e.g. DPD digital training signal (X_{ref}) 610, to compensate for the subsequent non-linearity and distortion effects that will be caused to the input signal by the transmitter circuit and shape the envelope at same time. In some examples, a look-up table 652 may be used to store the determined pre-distortion co-efficients.

In this manner, the frequency shift by f_{IF} of the transmit signal in the transmitter path via the SSB mixer 612, followed by the reverse frequency shift by f_{IF} of the transmit signal in the feedback path enables the frequency shifted 3^{rd} harmonic distortion content to be removed by averaging circuit 647.

Although in this example the introduction (and subsequent removal) of an intermediate frequency shift has been implemented in the digital domain via SSB mixers 612, 642, it is envisaged that the architecture could be adapted such that the intermediate frequency shift may be introduced by analog SSB mixers in the analog domain (i.e. post DAC in the transmitter path and pre-ADC in the receiver path).

Referring now to FIG. 7, a fourth simplified example block diagram 700 of a transmitter with a predistortion circuit with reduced harmonic distortion in a normal transmission mode of operation, is illustrated, in accordance with some examples of the invention. This fourth example block diagram 700 illustrates the circuit components employed in some of examples of a DPD normal transmission (compensation) mode of operation, i.e. after the DPD compensation values have been determined during a calibration mode of operation. As illustrated, the transmitter employs a signal generator 705 that generates a signal to be transmitted, such as an orthogonal frequency division multiplexed (OFDM) signal. This OFDM signal is predistorted (e.g. its amplitude and phase values are adapted to take into account the distortion caused by the power amplifier 324). In accordance with the examples of the present invention, the predistortion components also adapt the OFDM signal to reduce the effect of harmonic distortion on a transmitted signal due to the PLL 760, RF modulator 720 and thereafter the power amplifier 324, as determined in the preceding calibration training process. In this manner, the desired predistortion components may be pre-calculated and stored in DPD LUT 718 located within, or coupled to, the predistortion circuit 715. In this example, during the normal transmission mode of operation, the DAC clock frequency within RF modulator 720 may be reduced due to the inherent reduction in producing harmonic distortion components. This may, in some examples, result in lower current consumption.

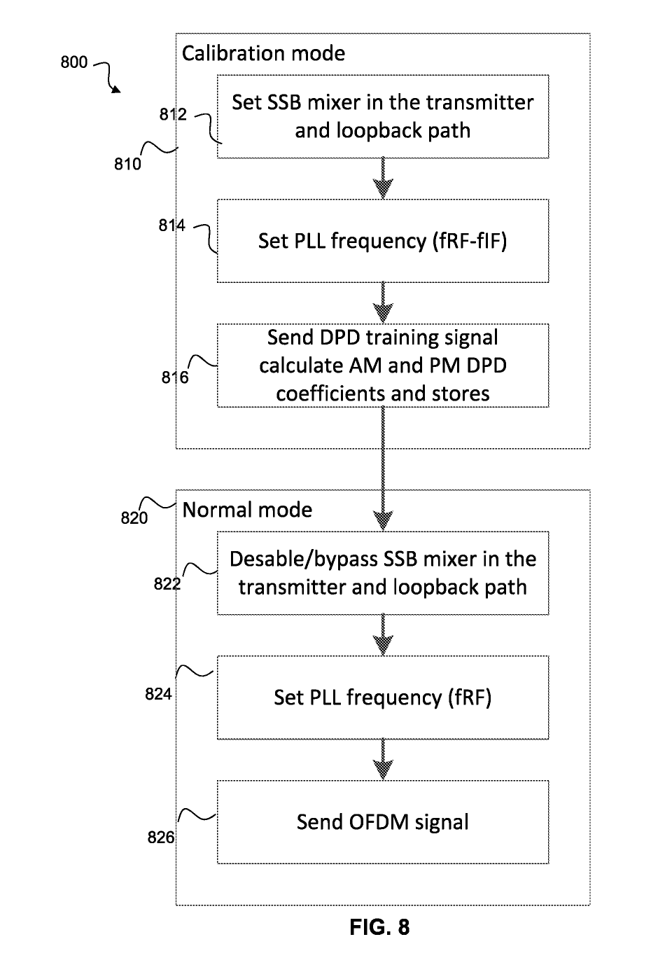

FIG. 8 illustrates an example flowchart 800 of a digital pre-distortion (DPD) calibration followed by the consequent normal operation process where some circuits used in the DPD training may be bypassed in accordance with some examples of the invention. In this example, the flowchart is divided into two modes of operation for the communication unit transmitter, a first calibration mode 810 and a second, subsequent normal transmission mode of operation 820. In this example, a calibration signal (which may be a DPD digital training signal (X_{ref})) is generated and provided to the transmitter. At 812, in this example, the SSB mixers in the forward and feedback paths are included in the transmitter path. At 814, in this example, the phase locked loop frequency of f_{RF}−f_{IF} is set in the transmitter path. The calibration signal is then routed through the transmitter circuit at 816, converted to analog form in an optional DAC, routed through a power amplifier, such that the output signal (X_{PA}) is an amplified analog representation of the DPD digital training signal (X_{ref}). A portion of the output signal (X_{PA}) is routed back to the DPD circuit in, down-converted (not shown) and converted back to digital form. At 816, the amplitude modulated and phase modulated distortions caused by the power amplifier and the associated DPD coefficients are measured and stored. Thus, the calibration process 810 may include sending a calibration signal to the transmitter, applying a DPD adjustment to the calibration signal and comparing a feedback signal from a transmitter power amplifier with a reference signal, e.g. the input calibration signal, and updating the DPD values, say in a DPD LUT, accordingly. This calibration process may be performed one or multiple times, for example to fine-tune the DPD values.

In the second, subsequent normal transmission mode of operation 820, the SSB mixers are then disabled or bypassed in both the forward and feedback paths, at 822. At 824, in this example, the phase locked loop frequency of f_{RF} is set in the transmitter path. At 826, a transmit orthogonal frequency division multiplex (OFDM) signal, in this example, is sent, with the DPD coefficients (and/or) filter parameters being set to reduce any harmonic distortion content of the transmitter signal, particularly reduce third order harmonic distortion. In this manner, a cleaner and more linear transmitter signal is output from the power amplifier.

In some example embodiments, the examples herein described may increase transmitter output power for low order modulation signals, due to the lower spectral regrowth, so long as the output power meets the spectrum mask specification.

In the foregoing specification, the invention has been described with reference to specific examples of embodiments of the invention. It will, however, be evident that various modifications and changes may be made therein without departing from the scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

However, other modifications, variations and alternatives are also possible. The specifications and drawings are, accordingly, to be regarded in an illustrative rather than in a restrictive sense.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected’, or ‘operably coupled’, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

For example, in some example embodiments, it is envisaged that a single processor may be configured to perform multiple functions and operations of circuits hereinbefore described. Furthermore, in some example embodiments, although the LUTs have been described individually, thereby suggesting that they may comprise separate memory elements, it is envisaged that a number or each may form a portion of a single LUT or memory element.

Also for example, the various components/modules, or portions thereof, may implemented as soft or code representations of physical circuitry or of logical representations convertible into physical circuitry, such as in a hardware description language of any appropriate type. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an’, as used herein, are defined as one, or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an’. The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The connections as discussed herein may be any type of connections suitable to transfer signals from or to the respective nodes, units or devices, for example via intermediary components. Accordingly, unless implied or stated otherwise, the connections may for example be direct connections or indirect connections. The connections may be illustrated or described in reference to being a single connection, a plurality of connections, unidirectional connections or bidirectional connections. However, different illustrated examples may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

It will be appreciated that, for clarity purposes, the above description has described embodiments of the invention with reference to different functional units and processors. However, it will be apparent that any suitable distribution of functionality between different functional units or processors, for example one or more shaping circuits, etc., may be used without detracting from the invention. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, lower spectral regrowth solutions have been described, wherein the aforementioned disadvantages with prior art arrangements have been substantially alleviated.

We claim:

1. A transmitter configured to operate in a training mode of operation and a normal transmission mode of operation, the transmitter comprising:
a signal generator arranged to generate a digital baseband signal that is representative of a signal for transmission;
a digital predistortion, DPD, circuit configured to predistort the digital baseband signal;
a first frequency shift circuit operably coupled to the DPD circuit and configured to frequency shift the signal for transmission in a first frequency direction, where the frequency-shifted signal is then transmitted to a power amplifier;
a feedback path coupleable to an output of the power amplifier and configured to route a portion of a power amplified predistorted signal to a second frequency shift circuit that is configured to frequency shift a fed back power amplified predistorted signal portion in a second frequency direction opposite to the first frequency direction; and
a calibration engine, located in the feedback path and coupled to the signal generator and arranged to receive and compare the digital baseband signal representative of a signal for transmission with the fed back power amplified predistorted signal portion shifted in the second frequency direction, wherein the calibration engine is configured to determine at least one DPD compensation value during a training mode of operation and wherein the first frequency shift circuit and second frequency shift circuit apply the frequency shift in a first direction and a second frequency direction opposite to the first frequency direction only in the training mode of operation.

2. The transmitter of claim 1 wherein the first frequency shift circuit and second frequency shift circuit comprise single sideband mixers configured to receive a frequency shift signal and the signal for transmission and generate a frequency shifted signal for transmission on a single sideband of the signal for transmission.

3. The transmitter of claim 1 wherein the first frequency shift circuit is located before the DPD circuit in a transmitter path.

4. The transmitter of claim 1 wherein the first frequency shift circuit is located after the DPD circuit in a transmitter path.

5. The transmitter of claim 1 wherein an input digital signal to the DPD circuit in a calibration process is an input digital linearization training signal.

6. The transmitter of claim 1 further comprising a filter located between the second frequency shift circuit and the calibration engine.

7. The transmitter of claim 1 wherein frequency shift circuits are bypassed in the normal transmission mode of operation.

8. The transmitter of claim 1 further comprising a radio frequency, RF, modulator comprising at least one low pass filter, LPF, coupled to at least one mixer in a forward path and a RF demodulator located in the feedback path.

9. The transmitter of claim 8 wherein the at least one LPF is bypassed in a training mode of operation.

10. The transmitter of claim 8 wherein the at least one LPF is set to a first cut-off frequency in a training mode of operation and a second cut-off frequency in a normal transmission mode of operation, wherein the first cut-off frequency is higher than the second cut-off frequency.

11. The transmitter of claim 8 further comprising a pre-emphasis filter located before the RF demodulator, wherein the pre-emphasis filter is configured to compensate for a frequency response applied to the transmit signal by the RF demodulator.

12. A communication unit comprises a transmitter comprising a transmitter configured to operate in a training mode of operation and a normal transmission mode of operation, the transmitter comprising:
a signal generator arranged to generate a digital baseband signal that is representative of a signal for transmission;
a digital predistortion, DPD, circuit configured to predistort the digital baseband signal;
a first frequency shift circuit operably coupled to the DPD circuit and configured to frequency shift the signal for transmission in a first frequency direction;
a power amplifier arranged to amplify the predistorted signal and provide a power amplified output thereof;
a feedback path coupled to an output of the power amplifier and configured to route a portion of the power amplified predistorted signal to a second frequency shift circuit that is configured to frequency shift a fed back power amplified predistorted signal portion in a second frequency direction opposite to the first frequency direction; and
a calibration engine, located in the feedback path and coupled to the signal generator and arranged to receive and compare the digital baseband signal representative of a signal for transmission with the fed back power amplified predistorted signal portion shifted in the second frequency direction, wherein the calibration engine is configured to determine at least one DPD compensation value during a training mode of operation and wherein the first frequency shift circuit and second frequency shift circuit apply the frequency shift in a first direction and a second frequency direction opposite to the first frequency direction only in the training mode of operation.

13. The communication unit of claim 12 wherein the first frequency shift circuit and second frequency shift circuit comprise single sideband mixers configured to receive a frequency shift signal and the signal for transmission and generate a frequency shifted signal for transmission on a single sideband of the signal for transmission.

14. The communication unit of claim 12 wherein the first frequency shift circuit is located before the DPD circuit in a transmitter path.

15. The communication unit of claim 12 wherein the first frequency shift circuit is located after the DPD circuit in a transmitter path.

16. The communication unit of claim 12 further comprising a radio frequency, RF, modulator comprising at least one low pass filter, LPF, coupled to at least one mixer in a forward path and a RF demodulator located in the feedback path.

17. The communication unit of claim 16 wherein the at least one LPF is bypassed in a training mode of operation.

18. The communication unit of claim 16 wherein the at least one LPF is set to a first cut-off frequency in a training mode of operation and a second cut-off frequency in a normal transmission mode of operation, wherein the first cut-off frequency is higher than the second cut-off frequency.

19. The communication unit of claim 16 further comprising a pre-emphasis filter located before the RF demodulator, wherein the pre-emphasis filter is configured to compensate for a frequency response applied to the transmit signal by the RF demodulator.

20. A method for limiting harmonic distortion of a transmitter signal that uses a digital predisortion circuit, the method comprising:
generating a digital baseband signal representative of a signal for transmission;
predistorting the digital baseband signal by a digital predistortion, DPD, circuit;
applying a first frequency shift to frequency shift the signal for transmission in a first frequency direction, and the frequency-shifted signal is then power-amplified;
feeding back a portion of the power amplified predistorted frequency shifted signal;
applying a second frequency shift to a fed back power amplified predistorted frequency shifted signal portion in a second frequency direction opposite to the first frequency direction;
receiving and comparing the digital baseband signal representative of a signal for transmission with the fed back power amplified predistorted signal shifted in the second frequency direction; and
determining at least one DPD compensation value to be applied in a DPD circuit, such that the determined at least one DPD compensation value compensates for harmonic distortion of the transmitter signal identified using the first frequency shift and the second frequency shift and wherein applying of a first frequency shift and a second frequency shift is performed solely during a training mode of operation.
